(19) United States
(12) Patent Application Publication
(10) Pub. No.: US 2017/0123057 A1
(43) Pub. Date: May 4, 2017

(54) SENSOR FOR A ROLLER TRACK AND METHOD FOR RECOGNIZING OBJECTS LOCATED ON A ROLLER TRACK

(71) Applicant: SICK AG, Waldkirch (DE)

(72) Inventors: Oliver PRINZ, Waldkirch (DE); Simon KERN, Waldkirch (DE)

(21) Appl. No.: 15/315,781

(22) PCT Filed: Jun. 23, 2015
(86) PCT No.: PCT/DE2015/100255

§ 371 Date: Dec. 2, 2016

(30) Foreign Application Priority Data
Jul. 4, 2014 (DE) 10 2014 109 402.6

(51) Int. Cl. G01S 13/04; H01Q 13/12; B65G 43/08; H01Q 21/06; B65G 13/00; B65G 39/02; G01S 7/03; H01Q 21/00

(52) U.S. Cl. CPC G01S 13/04; G01S 7/032; H01Q 13/12; H01Q 21/0043; H01Q 21/065; B65G 13/00; B65G 39/02; B65G 43/08; B65G 2203/0208

(57) ABSTRACT

A sensor (10) for a roller track (16) is provided having a transmitter (24); a receiver (26); and a sensor element (12) which is integrated into a roller (14) of the roller track (16), which is arranged between the rollers (14) of the roller track (16) or which is arranged at the roller track (16); and having an evaluation unit (28) for recognizing objects located on the roller track (16) using a sensor signal of the sensor element (12). In this respect, the sensor element (12) has an antenna element (20); the sensor signal is a high frequency signal fed into the antenna element (20) by the transmitter (24), irradiated and subsequently again received in the receiver (26) via the antenna element (20); and the evaluation unit (28) is configured to recognize the presence of objects with reference to influences of the high frequency signal.

The invention relates to a sensor for a roller track and to a method of recognizing objects located on a roller track respectively.

Roller tracks are as a rule used as roller conveyors in storage and conveying technology. Some of the rollers have an active drive which sets them into rotation. The remaining passive rollers can be co-moved by the active rollers via belts or the objects set into motion bridge such rollers due to inertia. To control the material flow, the roller track should be monitored for the presence of objects at specific positions of the conveying path. The most varied sensors are known for this purpose such as optical sensors, magnetic sensors, inductive sensors or capacitive sensors which are attached to the corresponding location of the conveying path to detect the conveyed products on the roller track.

The installation of such sensors using a suitable fastening technique and cabling for connection to an energy supply and to a communication network, that is to a control unit or in a ladder network to further sensors, requires a substantial effort and/or costs, additional space requirements and an individual adjustment of the numerous separately installed sensors. In addition, externally installed sensors are generally prone to mechanical impairments by the environment such as contamination of or damage to the detection surfaces. This in particular applies with optical sensors such as light barriers or light grids which observe the roller track from the side or from below. The servicing effort is thereby increased and a robust housing configuration furthermore becomes necessary for the mechanical protection of the sensors.

It is therefore proposed in the prior art, for instance DE 101 31 019 A1, to integrate a sensor system directly into rollers of a roller track. The technologies named in this respect are, however, merely listed without details and each leave serious problems unsolved. For example, the availability of optical sensors frequently suffers due to contaminants. Other principles such as capacitive sensors or inductive sensors cannot reliably distinguish fluctuations of the sensor signal due to various external influences such as irregularities in the movement of the roller due to bearing play, temperature changes, wear or contamination from the effects by an object on the roller. It is also of no help here if, for example with capacitive sensors, rollers of plastic are to be excluded, since it is not explained how this could be achieved. The functional principle with respect to a likewise named embodiment having a radar transmitter or microwave transmitter is left completely open except for the mentioning of these elements.

DE 20 2007 015 529 U1 discloses a roller for a roller track having an integrated capacitive sensor which additionally provides a reference sensor at a side remote from the conveying side. With an object conveyed over the rollers, a switch signal is then determined from a difference signal between the signal of the actual sensor and of the reference sensor. It is additionally proposed to arrange a plurality of sensors behind one another in the longitudinal direction of the roller.

It is therefore the object of the invention to make possible a reliable presence detection of objects on a roller track.

This object is satisfied by a sensor for a roller of a roller track and by a method of recognizing objects located on a roller track in accordance with the respective independent claim. The sensor element of the sensor is integrated into a roller of the roller track or is arranged between the rollers, preferably in parallel therewith. Alternatively, the sensor element is preferably aligned transversely to the rollers at the roller track, that is in particular in parallel with the direction of movement of the objects to the side of, beneath or above the roller track. The invention now starts form the basic idea of utilizing a high frequency signal for the recognition of objects which is irradiated by a transmitter via an antenna element into a free space above the roller track and is then received in a receiver via the antenna element. The high frequency signal is an electromagnetic signal, for example a radio frequency signal, but may also have a higher frequency than an upper radio frequency limit. Objects in the region above the roller track influence the high frequency signal and this effect is utilized for the presence recognition of the objects. The transmitter and the receiver can together be formed as a transceiver. It is additionally conceivable that the high frequency signal is irradiated and received by different single antennas of the antenna element.

The invention has the advantage that only a minimal assembly effort without additional space requirements is made possible by the integration into the roller track or even into a roller, wherein the sensor is simultaneously protected from external influences. In this respect, the sensor is of a simple design and manages with only a small measuring effort. In contrast to optical sensors, the sensor based on high frequency signals is insensitive to dust and contaminants.

A particularly robust, reliable and simple presence recognition thus becomes possible for objects on a roller track.

The sensor is preferably integrated into a roller or into a frame of the roller track. In embodiments in which the sensor element is already integrated into a roller, this means the advanced integration of elements of the sensor such as the transmitter, the receiver and the evaluation unit. Such a system integrated into the roller is the most compact, but additional exposed elements are also avoided and space requirements are reduced on an integration of the sensor element or other elements of the sensor into a frame of the roller track. Only a connection line for the supply and the data connection is required. Even this connection line can be avoided by wireless communication such a radio or by a wireless or autonomous supply.

The antenna element preferably has a hollow conductor antenna. In this respect, the high frequency signal is first conducted in a metallically conductive hollow space and is then irradiated at openings of the metallic sleeve. It is then no a metallic dipole which has the actual antenna function, but rather the respective opening.

The roller is particularly preferably configured as a hollow conductor antenna in that the roller has a metallic sleeve having openings. The high frequency signal is irradiated at the openings and can interact with the objects to be recognized. For a large detection zone, openings are therefore preferably provided over at least a large part or over the full length of the sensor element. In a radial direction, a suitable arrangement of the openings depends on whether the sensor element as a roller co-rotated or not. In the co-moved case, the openings should preferably be distributed over the periphery since otherwise the sensor element is periodically in the way of a presence recognition. In the resting case, openings are to be applied in the direction of the objects to be recognized. Slits have a particularly suitable opening shapes. It is possible to provide a dielectric in the interior of the hollow conductor antenna. Its metallic sleeve makes a hollow conductor antenna particularly resistant and long-life as a roller.

The antenna element preferably has a plurality of hollow conductor antenna elements. For example, a plurality of thin hollow conductor antennas are introduced into the sensor element and in particular into a roller. A metallic sleeve of the sensor element is again interrupted for this purpose by openings which in this case do not have to have an irradiating effect, but rather only have to allow the field already irradiated by the hollow conductor elements to pass. Alternatively, there is no common metallic sleeve, for example in that the plurality of hollow conductor antenna elements are embedded into a dielectric. The high frequency signals of the plurality of hollow conductor antenna elements can be individually evaluated and the results can only be combined subsequently at an algorithmic level. It is also conceivable to distribute the high frequency signal over the plurality of hollow conductor antenna elements by a splitter or combiner at the transmission side, in particular having a similar radial direction, and to combine it at the reception side.

The sensor element preferably has at least one antenna structure at its surface. The antenna structure can in this respect be located both on and beneath the surface of the sensor element and in particular of the roller, that is it can be covered by a dielectric. The above statements on the distribution of openings of a hollow conductor antenna apply accordingly with respect to the distribution of antenna structures over the longitudinal extent and over the periphery of the sensor element.

The antenna structure preferably has at least one patch antenna. It can be arranged in a particularly compact manner at the surface and offers a very large number of degrees of freedom for the antenna design. In principle, other construction shapes of antennas are also possible, but are at least much more difficult to integrate into a roller and structures may arise outside a roller which could be avoided in other embodiments. A plurality of patch antennas can be controlled individually or group-wise, with the groups preferably being combined in a similar radial direction in order to respond approximately simultaneously to an object.

The evaluation unit is preferably configured to recognize objects using reflections of the high frequency signal. The preferably means the measurement of the signal scattered back by the detected object. If the irradiated high frequency signal is incident onto objects, it is at least partly reflected. A time progressions of the high frequency signal with echoes corresponding to the objects thus results as a received signal. This curved line can be sampled and then digitally assessed in its total information content, but can also be evaluated in an analog manner, for example with reference to thresholds.

The evaluation unit is preferably configured to determine a signal transit time of the high frequency signal up to an object edge and to determine the position of a recognized object on the roller track from this. The high frequency signal delivers more measured information than the simple presence which is, for example, detected by determination of a signal transit time to localize object edges. This produces information on the position and size of the object. This information on position and size can be refined by multiple measurements using a plurality of sensors or sensor elements arranged along the roller track and/or by a repeated measurement while taking account of the conveying speed.

The evaluation unit is preferably configured to modulate the amplitude, frequency and/or phase of the high frequency signal at the transmission side and to evaluate this modulation at the reception side. A signal transit time method can thus in particular be realized, for example a phase process with a determination of the phase offset, a pulse process or an FMCW (frequency modulated continuous wave) process.

The antenna element preferably irradiates the high frequency signal with at least a portion in a direction of movement of the objects on the roller track and the evaluation unit is configured to detect the objects with reference to a modified frequency of the high frequency signal on the basis of a Doppler shift. The Doppler shift only occurs when irradiated high frequency signals have at least portions in the direction of movement of the objects. The antenna lobes can be tilted a little or completely in the direction of movement for this purpose. Not only the presence, but also the speed of the objects is preferably measured via the Doppler effect.

The antenna element is preferably configured to produce a movable antenna lobe to dynamically scan a region of the roller track. The sensor thus works over a much increased detection zone like scanning radar with or without range finding. The movement of the antenna lobe is preferably not achieved by a mechanical movement of the antenna, although this would be conceivable in principle, but rather by an electronic control of a plurality of single antennas, for instance by time multiplexing or phase-shifted control signals. An embodiment as scanning radar is particularly suited for the installation at or the integration into the frame.

The evaluation unit is preferably configured to determine a calibration signal in the absence of objects in advance and then to take it into account for the recognition of objects. Those influences on the high frequency signal which are not caused by an object to be recognized are thus detected in a kind of blank calibration. They are then taken into account in a simple manner in operation by deducting the calibration signal from the respective received high frequency signal. This procedure implies a reference comparison. If significant differences from zero remain after the deduction of the calibration signal, a conclusion can be drawn on the presence of an object.

The evaluation unit is even more preferably configured to determine or adapt the calibration signal in operation with reference to a history of high frequency signals. The blank calibration without an object therefore does not only take place initially, here, but dynamically. It is ultimately preferably a filter having low-pass properties which therefore forgets fast changes by objects and influences on the high frequency signal lying far in the past. The filter parameters should be set such that slowly moved objects or objects in the temporary jam do not yet trigger any adaptation, but only long-term effects such as deposits at the roller.

The evaluation unit is preferably configured to digitize received signals and to carry out the further signal evaluation in FPGAs and/or microcontrollers. A transformation of the digitized signals from the time range into the frequency range, where the further evaluation takes place, is specifically carried out. After a pre-processing which carries out the standardizing of the signals, interfering influences are suppressed by specifically adapted filters. The objects are subsequently detected. A detector is preferably used for this purpose which adaptively sets a detection threshold. The known objects are tracked by their distance to minimize the likelihood of the detection of non-present objects.

In an advantageous further development, a roller is provided with a sensor in accordance with the invention integrated therein. The roller can have its own drive, that is it can be an active roller. The sensor then preferably utilizes the supply and control lines of this drive. The sensor can, however, also be used in a passive roller without its own drive. The sensor then requires its own connections or is supplied and communicates wirelessly. It is also conceivable to equip the sensor with a battery or with its own energy generation from the rotational movement.

The method in accordance with the invention can be designed in a similar manner by further features and shows similar advantages in this respect. Such further features are described in an exemplary, but not exclusive, manner in the dependent claims following the independent claims.

The invention will also be explained in the following with respect to further advantages and features with reference to the enclosed drawing and to embodiments. The Figures of the drawing show in:

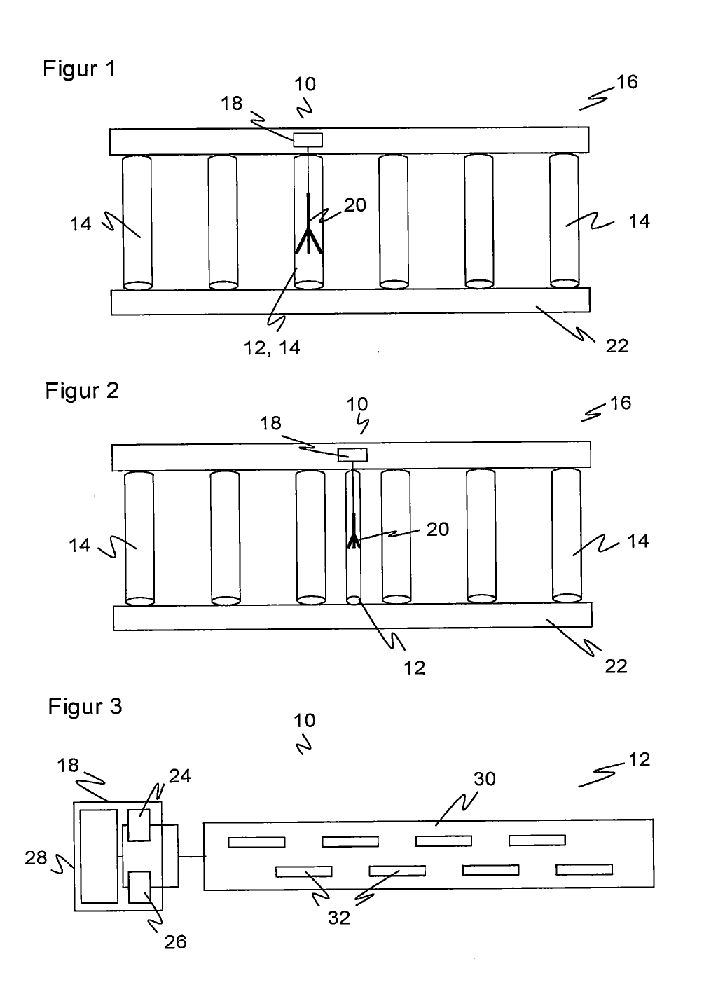

FIG. 1 a plan view of a roller track with a sensor integrated into a roller for the presence recognition of objects on the roller track;

FIG. 2 a plan view of a roller track with a sensor for the presence recognition of objects whose sensor element is arranged between the rollers;

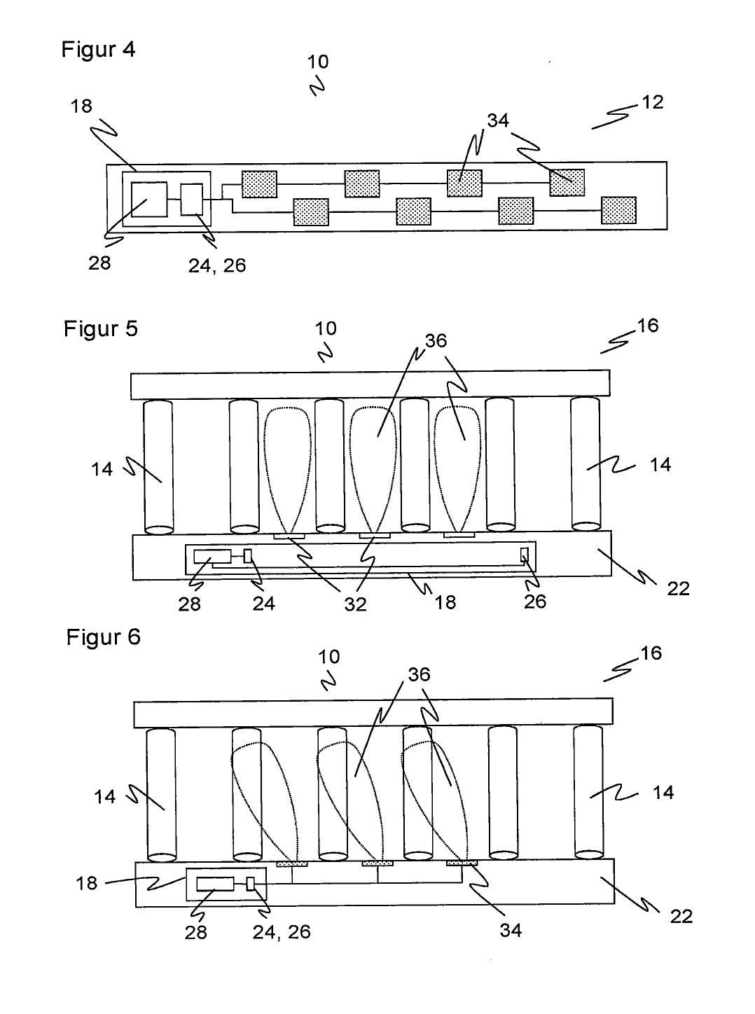

FIG. 3 a block diagram of a sensor with a hollow conductor antenna;

FIG. 4 a block diagram of a sensor with an antenna element which has a plurality of antenna structures at its surface;

FIG. 5 a plan view of a roller track with a sensor integrated into its frame for the presence recognition of objects on the roller track;

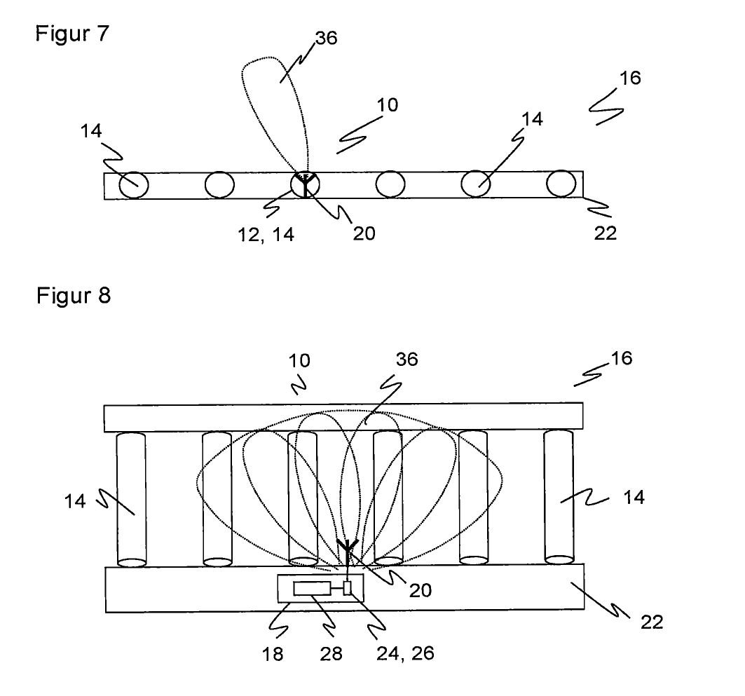

FIG. 6 a plan view of a sensor similar to FIG. 5, but with antenna structures instead of a hollow conductor antenna and tilted antenna lobes;

FIG. 7 a side view of an embodiment of a sensor integrated into a roller and with a tilted antenna lobe; and

FIG. 8 a plan view of a roller track with a sensor which has a pivotable antenna lobe for scanning a region on the roller track.

FIG. 1 shows a plan view of a sensor 10 whose sensor element 12 is integrated into a roller 14 of a roller track 16. The rollers 14 rotate actively or passively by co-movement with an object, not shown, which moves along the roller track 16. The sensor 10 has a sensor head 18 whose elements will be explained in more detail further below with reference to FIG. 3. The sensor element 12 has at least one antenna 20 which is integrated into the roller 14 or is formed by the roller 14. The sensor head 18 is integrated into a frame 22 of the roller track 16 in the embodiment in accordance with FIG. 1. In other embodiments, the sensor head 18 is likewise installed in the roller 14.

FIG. 2 shows a plan view of an alternative arrangement where the sensor element 12 is a separate component which is arranged between, in particular in parallel with, the rollers 14. The design of the separate sensor element 12 can be similar to a roller 14, that is it can likewise be manufactured as a circular cylinder from the same materials. The separate sensor element 12, however, does not necessarily co-rotate, but can also be supported rotationally fixedly in the frame 22 and can have a different diameter than a roller 14.

FIG. 3 shows a block diagram of an embodiment of the sensor 10. The sensor head 18 has a transmitter 24, a receiver 26 and a control and evaluation unit 28 connected thereto. The transmitter 24 and the receiver 26 can together be formed as a transceiver. The coupling to the antenna 20 configured as a hollow conductor antenna 30 here takes place capacitively or directly by a connection piece, for example. It would be an alternative embodiment to integrate a separate transmission and reception antenna into the sensor element. The hollow conductor antenna 30 acting as a sensor element 12 can be integrated into a roller 14 as in FIG. 1, between rollers 14 as in FIG. 2 or, as illustrated below with reference to FIGS. 5 and 6, arranged at the roller track 16 and in particular integrated into its frame 22. For example, a roller 14 of the roller track is configured as a round hollow conductor antenna which irradiates in all directions or an antenna of a round or rectangular hollow conductor is arranged between the rollers 14. It is a further option to place a plurality of thin hollow conductor antennas into the sensor element 12 such that the directions are fed separately from one another. This has the advantage that the hollow conductor design is substantially independent of the geometry of the sensor element 12 or of the roller 14. In the case of a plurality of single antennas, the evaluation is carried out singly, group-wise or together.

The hollow conductor antenna 30 has openings 32 or slits at which the high frequency signal is irradiated. The number, geometry and arrangement of the openings 32 are fixed in an antenna design to recognize the presence of objects as reliably as possible. Depending on whether the sensor element 12 rotates or not, openings 32 at the surface are sufficient or openings 32 should preferably be distributed over the total periphery.

A hollow conductor antenna 30 is characterized by the complement to a dipole, i.e. the irradiating element is not the metallic dipole, bur rather the interruption of the metallic surface by a slit. This slit is λ/2 long in the simplest case. An antenna diagram such as dipole array can be produced by the arrangement of a plurality of slits along a hollow conductor at intervals of λ/2. The advantage is, however, that the feed network is already integrated.

The high frequency signal irradiated through the openings 32 is at least partly reflected at objects. The larger the jump in the dielectricity constant between air and object, the more power is reflected and a correspondingly large amount of power arrives back in the receiver. The change of the fed in high frequency signal is evaluated in the reflection arrangement in accordance with FIG. 3 at the antenna input.

FIG. 4 shows a block diagram of a further embodiment of the sensor 10. The antenna 20 is implemented here in that in particular metallic antenna structures 34 are arranged at the surface of the sensor element 12. At the surface can mean that the antenna structures 34 lie on the surface and thus come into direct contact with objects in the case of integration into a roller 14. It is, however, also conceivable to attach the antenna structures beneath the surface, that is, for example, to provide a dielectric layer of a protective material. Analog to the hollow conductor antenna 30, an antenna 20 having antenna structures 34 as in FIG. 1 can also be integrated into a roller 34, as in FIG. 2 between rollers 14 or, as illustrated below with reference to FIGS. 5 and 6, arranged at the roller track 16 and in particular integrated into its frame 22.

Unlike FIG. 3, the sensor head 18 is likewise shown integrated into the sensor element 12 and in particular into the roller 14. In addition, the transmitter 24 and the receiver 26 are combined to form a transceiver. These variations are, however, exchangeable and are possible both with a hollow conductor antenna 30 and with antenna structures 34 at the surface.

A high frequency signal can be irradiated into the free space via the antenna structures 34. Patch antennas with or without a reflector are particularly suited. The patches can be controlled separately via a plurality of feed points or can be connected to one another via a feed network so that there is a common feed point. Any intermediate shape, that is that groups of patches are combined, is equally possible. The drawn connection lines of the antenna structures 34 are therefore only to be understood symbolically. The same as described above with respect to the openings 32 of a hollow conductor antenna 30 practically applies to the distribution of the antenna structures 34 with respect to the number, to the arrangement in the longitudinal and peripheral directions and to the geometry. A large number of degrees of freedom thereby result for an optimum antenna design. For example, antenna structures 34 are distributed evenly over the length and the periphery of the sensor element 12 or of the roller 14. The resulting antenna diagram is then so-to day round over the periphery of the antenna, but bundled along the axis.

Whereas in the previously shown embodiments, the antenna 20 was integrated into a roller 14 or was arranged between rollers 14, FIGS. 5 and 6 show further embodiments with integration of the antenna 20 into the frame 22 of the roller track 16. It would also be conceivable to accommodate the antenna 20 outside the frame 22 next to the roller track 16, that is, for example, to the side of, beneath or above the roller track 16. The design and the detection principle of the antennas 20 correspond in this arrangement to what was said with respect to FIG. 3 and FIG. 4. A design as a hollow conductor antenna having openings 32 as shown in FIG. 5 or having antenna structures 34 as shown in FIG. 6 is therefore in particular possible, just as the sensor head 18 can be co-integrated or not or the transmitter 24 and receiver 26 can be combined to form a transceiver.

Objects are only detected when they are located in the antenna lobes 36. Since the detection is not necessary everywhere at the roller track 16, it is sufficient to restrict the openings 32 or antenna structures 34 to the sections where information on objects is to be detected. The feed of individual hollow conductor antennas or antenna structures 34 can be implemented by cable or by a common hollow conductor which is arranged in parallel with the roller track or is integrated into the frame 22.

For an evaluation in all the embodiments described up to now, the reflections or echoes of the high frequency signal can be used which a jump in the dielectricity constant between air and object produces. The reflected energy again couples to the antenna 20 and moves in a wired manner to the receiver 26 and into the evaluation unit 28. The amplitude and phase of the received high frequency signal can be evaluated, and indeed in an absolute manner, relative to the irradiated high frequency signal or relative to a reference channel.

A simple possibility of determining the presence of objects is a monitoring of whether a significant portion of the high frequency signal was reflected at all. The evaluation can respectively take place by a threshold assessment, wherein the threshold is selected in the context of the desired sensitivity of the system, for instance whether small objects such as letters are to be detected, and of the interference influences such as contamination, moisture and EMC. This threshold can evaluate the time-dependent high frequency signal or a summary coefficient such as the reflection factor. A comparison with a reference channel or with a pre-stored reference signal is furthermore conceivable since a part reflection is almost always caused independently of objects by parts of the sensor 10, of the roller track 16 or of other structures.

The evaluation unit 28 cannot only draw a conclusion on the presence of objects binarily form the time position of the reflected signal portions within the high frequency signal, but can also determine the distance of the object from the antenna 20 and thus the object position via a signal transit time process. At least the position of the frontmost edge of an object can thus be detected. On the determination of the position of rear edges of an object which deliver size information on the object or of further objects on the same sensor element 12, it must be noted that the present object already delays the signal propagation here. The rear edge can therefore only be roughly estimated or can be determined using knowledge or assumptions with respect to the dielectricity constant of the object. Since the high frequency signal is transmitted by non-metallic objects, a plurality of objects at different distances from the antenna 20 can also be identified even though they cover one another optically. In this respect, an exact object position of rear objects is not necessarily obtained for the named reasons, but at least the recognition valuable per se is obtained that a plurality of objects are present on the same sensor element 12.

The high frequency signal is modulated in amplitude, frequency and/or phase for the determination of the signal transit times. An amplitude modulation at 0% and 100% corresponds to a pulse modulation, with the amplitude, however, not necessarily being modulated in pulse form provided only that an unambiguous time behavior remains readable such as with multiple pulses or jump functions. A phase modulation allows the determination of the phase shift between the transmitted and received high frequency signal. An example for a method with frequency modulation is FMCW.

An alternative or additional evaluation is a Doppler measurement. This requires that the antenna lobes 36 have at least one component in the direction of movement of the objects on the roller track 16. FIG. 6 illustrates how the Doppler effect can be used in an improved manner by an oblique positioning of the antenna lobes 36. FIG. 7 shows this in a sectional view or side view for the case of an antenna 20 which is integrated into a roller 14 or is arranged between rollers 14. An alignment of the antenna lobes 36 in exactly one direction of movement would be ideal for a Doppler measurement. Otherwise, the antenna lobe 36 is divided into a component toward or away from the antenna 20 which can be used and a component perpendicular thereto which does not contribute anything to the Doppler evaluation.

Under the named conditions, a Doppler shift results by the movement of the object which can be measured the more clearly, the larger the speed component is in the direction of the antenna 20. In a simple example, a high frequency signal of a constant frequency is irradiated by the antenna 20. The receiver evaluates the difference between the transmitted frequency and the received frequency. The difference frequency can be converted into the speed of the object on the roller track 16. With a frequency mix, the Doppler effect equally occurs, only the evaluation is somewhat more complex.

FIG. 8 shows a further embodiment with an antenna 20 whose antenna lobe 36 can be pivoted in the manner of scanning radar in order thus to cyclically detect a larger region of the roller track 16. Although the pivot movement can in principle be achieved by a mechanical movement of the antenna 20, this is preferably done by intelligent control of a plurality of single antennas, in particular patches of an antenna structure 34, by phase shifting or by a simultaneous control, but with different high frequency signals or phases. In principle, such a pivotable antenna 20 can also be integrated into a roller 14 or can be arranged between rollers 14, but the advantage of a larger detection zone becomes clearer with an arrangement at the roller track 16 as in FIG. 8.

Finally, it is again pointed out that the features shown in the Figures can also be combined differently. It is thus not only possible in each case to integrate the sensor element 12 into the roller 14, to arrange it between rollers 14 or at the roller track 16, to combine the transmitter 24 and the receiver 26 to form a transceiver, to integrate it into the roller 14 or into the frame 22 or to arrange it in reflection or transmission. Combinations of measurement principles are also conceivable, that is sensors 10 with different antenna constructions, antenna arrangements or antenna designs presented here, but also additional sensors in rollers 14 or not which are based on non-irradiated high frequency signals or completely different physical principles such as an optical or capacitive detection.

In an embodiment of the invention, the evaluation unit 28 has at least two of the following units: a pre-processing, a filter to suppress interference influences, an adaptive detector, a tracker.

In a further embodiment, the sensor element 12 has separately fed antenna elements 20 for the transmitter and the receiver and can furthermore have more than one antenna element 20 whose detection results are linked to one another in the evaluation unit 28.

1. A sensor for a roller track having a transmitter; a receiver; and a sensor element, with the sensor element being integrated into a roller of the roller track, and with the sensor element being arranged either between the rollers of the roller track or at the roller track; and having an evaluation unit for recognizing objects located on the roller track using a sensor signal of the sensor element,
wherein the sensor element has an antenna element; wherein the sensor signal is a high frequency signal fed into the antenna element by the transmitter, irradiated and subsequently again received in the receiver via the antenna element; and wherein the evaluation unit is configured to recognize the presence of objects with reference to influences of the high frequency signal.

2. The sensor in accordance with claim 1,
wherein the sensor is integrated into a roller or into a frame of the roller track.

3. The sensor in accordance with claim 1,
wherein the antenna element has a hollow conductor antenna.

4. The sensor in accordance with claim 3,
wherein the roller is configured as a hollow conductor antenna in that the roller has a metallic sleeve with openings.

5. The sensor in accordance with claim 3,
wherein the antenna element has a plurality of hollow conductor antenna elements.

6. The sensor in accordance with claim 1,
wherein the sensor element has at least one antenna structure at its surface.

7. The sensor in accordance with claim 6,
wherein the antenna structure has at least one patch antenna.

8. The sensor in accordance with claim 1,
wherein the evaluation unit is configured to recognize objects with reference to reflections of the high frequency signal.

9. The sensor in accordance with claim 1,
wherein the evaluation unit is configured to determine a signal transit time of the high frequency signal up to an object edge and to determine the position of a recognized object on the roller track from this.

10. The sensor in accordance with claim 1,
wherein the evaluation unit is configured to modulate at least one of the amplitude, frequency and phase of the high frequency signal at the transmission side and to evaluate this modulation at the reception side.

11. The sensor in accordance with claim 1,
wherein the antenna element irradiates the high frequency signal with at least a portion in a direction of movement of the objects on the roller track and the evaluation unit is configured to detect the objects with reference to a modified frequency of the high frequency signal on the basis of a Doppler shift.

12. The sensor in accordance with claim 1,
wherein the antenna element is configured to produce a movable antenna lobe to dynamically scan a region of the roller track.

13. The sensor in accordance with claim 1,
wherein the evaluation unit is configured to determine a calibration signal in the absence of objects in advance and then to take it into account for the recognition of objects.

14. The sensor in accordance with claim 13,
wherein the evaluation unit is further configured to determine or to adapt the calibration signal in operation on the basis of a history of high frequency signals.

15. The sensor in accordance with claim 1,
wherein the evaluation unit is configured to carry out the processing in the frequency range.

16. The sensor in accordance with claim 1,
wherein the evaluation unit includes at least two of the following units: a pre-processing, a filter to suppress interfering influences, an adaptive detector, a tracker.

17. The sensor in accordance with claim 1,
wherein the sensor element has separately fed antenna elements for the transmitter and the receiver.

18. The sensor in accordance with claim 1,
wherein the sensor element has more than one antenna element whose detection results are linked to one another in the evaluation unit.

19. A roller having a sensor for a roller track having a transmitter; a receiver;
and a sensor element, with the sensor element being integrated into the roller, and with the sensor element being arranged either between the rollers of the roller track or at the roller track; and having an evaluation unit for recognizing objects located on the roller track using a sensor signal of the sensor element,
wherein the sensor element has an antenna element; wherein the sensor signal is a high frequency signal fed into the antenna element by the transmitter, irradiated and subsequently again received in the receiver via the antenna element; and wherein the evaluation unit is configured to recognize the presence of objects with reference to influences of the high frequency signal.

20. A method of recognizing objects located on a roller track by evaluating a sensor signal of a sensor element, with the sensor element being integrated into a roller, and with the sensor element being arranged either between rollers of the roller track or at the roller track, the method comprising the steps of:
feeding a high frequency signal into an antenna element of the sensor element,
irradiating the high frequency signal via the antenna element and, subsequently, again receiving the high frequency signal via the antenna element to recognize the presence of objects on the basis of influences of the high frequency signal.
